(19) United States
(12) Patent Application Publication
(10) Pub. No.: US 2012/0081065 A1
(43) Pub. Date: Apr. 5, 2012

(54) OVERCURRENT LIMITING FOR THE CLOSED-LOOP CONTROL OF CONVERTER-FED THREE-PHASE MACHINES

(75) Inventors: PETER KRAFKA, SCHRIESHEIM (DE); MICHAEL RAMPE, WEINHEIM-HOHENSACHSEN (DE)

(73) Assignee: BOMBARDIER TRANSPORTATION GMBH, BERLIN (DE)

(21) Appl. No.: 13/299,832

(22) Filed: Nov. 18, 2011

Related U.S. Application Data
(63) Continuation of application No. PCT/EP2010/002832, filed on May 4, 2010.

(30) Foreign Application Priority Data
May 18, 2009 (DE) 10 2009 021 823.8

(51) Int. Cl. H02P 23/08

(52) U.S. Cl. 318/798

(57) ABSTRACT

A method and a structure operate a three-phase machine, which is fed by a three-phase converter, using a stator flux regulator and either a slip frequency regulator or a torque regulator. A torque-forming fundamental-frequency current component of the stator current is limited by limiting a setpoint value that is supplied to the slip frequency regulator or to the torque regulator to a maximum slip frequency value maximum torque value. The flux-forming fundamental-frequency current component of the stator current is limited by limiting the speed at which a setpoint value supplied to the stator flux regulator changes to a maximum value. The maximum slip frequency value or maximum torque value is calculated on the basis of a prescribed maximum current value for a stator current fundamental-frequency magnitude of the stator current and on the basis of a filtered actual value of the flux-forming fundamental-frequency current component of the stator current.

### CROSS-REFERENCE TO RELATED APPLICATION

This is a continuation application, under 35 U.S.C. §120, of copending international application No. PCT/EP2010/002832, filed May 4, 2010, which designated the United States; this application also claims the priority, under 35 U.S.C. §119, of German patent application No. DE 10 2009 021 823.8, filed May 18, 2009; the prior applications are herewith incorporated by reference in their entirety.

### BACKGROUND OF THE INVENTION

### Field of the Invention

The present invention relates to an open-loop and/or closed-loop control device for the operation of a three-phase machine which is fed by a three-phase converter. The device has an open-loop and/or closed-loop control structure (the structure, for short) having a stator flux regulator (i.e. a controller which regulates the magnetic flux of the stator in the machine) and a slip frequency regulator or a torque regulator. The invention also relates to an appropriate method for the operation of a converter-fed three-phase machine and to a rail vehicle in which such a structure effects open-loop or closed-loop control of the operation of the drive motor(s).

International patent disclosure WO 2008/052714 A1 describes a device having such a structure by way of example for a three-phase asynchronous machine. The device or the method is intended to be used for high-performance applications, such as traction converters for supplying power to drive motors for rail vehicles. The aim is to allow mean-value-based and instantaneous-value-based pulse pattern generation for actuating the converter, with high dynamic demands, particularly for traction applications in rail vehicles, being intended to be met while making optimum use of the available input voltage for the converter. The present invention relates particularly to the same methods and open-loop and/or closed-loop control devices and the same applications.

In the case of open-loop and/or closed-loop controllers which, like the structure in the present invention, regulate the stator flux and the torque or the slip frequency, it is possible, without additional regulatory measures, for inadmissibly large current amplitudes to arise which would result in damage or destruction of the converter or the machine if no secondary protective measures, such as overcurrent disconnection of the converter, were taken. In the case of alternative structures which, by way of example, regulate the flux-forming and torque-forming components of the stator current (e.g. described in WO 2005/018086), regulatory overcurrent protection can be ensured by suitable limiting of the setpoint values for the current. By contrast, in the case of structures with a stator flux regulator and with a slip frequency regulator or a torque regulator, the stator current is not regulated directly, which means that additional measures for limiting the stator current are necessary. Such previously known measures achieved this object only inadequately, which means that the secondary protective measure of overcurrent disconnection responded relatively frequently.

The inadmissibly large current amplitudes, and hence the protective disconnections, can arise particularly during highly dynamic processes in the course of operation of the machine, i.e. in the case of rapid changes in the voltage of the intermediate circuit which supplies the traction inverter(s) with power, in the case of rapid changes in the speed of the machine, in the case of rapid changes in the torque needing to be produced by the machine and/or in the case of rapid changes in the desired magnetic flux in the stator of the machine.

The publication “Schnelle Drehmomentregelung im gesamten Drehzahlbereich eines hochausgenutzten Drehfeldantriebs” [Fast Torque Regulation Throughout the Speed Range of a Heavily Utilized Three-Phase Drive] by Dieter Maischak, progress reports, VDI series 8, No. 479, Dusseldorf, Germany, VDI publishers 1995, ISBN 3-18-347908-7, has proposed limiting the slip frequency setpoint value of the closed-loop control to a steady-state maximum stator current value. In this case, it is assumed that particularly the magnetic flux of the machine does not change, i.e. that the time derivation of the rotor flux is approximately equal to zero. If rapid flux changes arise, however, i.e. the machine is in the nonsteady magnetic state, a comparatively large magnetization current (this includes the case of demagnetization, i.e. also a negative magnetization current) in the stator is temporarily required for flux adjustment. In principle, limiting the slip frequency cannot limit the magnetization current and therefore cannot safely prevent overcurrent disconnections on the basis of large magnetization current amplitudes.

The method proposed by Maischak therefore cannot be used in all operating situations of the machine (particularly in the case of simultaneous flux and torque demands, as is often the case when operating rail vehicles) to safely limit the stator current, by regulatory means, to a value which allows continuous operation of the machine at all times without secondary protective measures such as overcurrent disconnections of the converter. In particular, when operating streetcars, it must be possible at all times to use the drive motor to produce a torque which resists the travel of the streetcar. For safety reasons, this dynamic braking by means of the machine is required as a second independent brake so as not to be reliant exclusively on the mechanical brake of the vehicle. If the vehicle is rolling essentially without any driving force, for example, and needs to be dynamically braked quickly, it is simultaneously necessary to quickly increase the stator flux and the torque produced by the machine. For dynamic braking, the drive is no longer available if the converter is disabled, however.

A further disadvantage of the method proposed by Maischak is that the steady-state stator current limiting is essentially dependent on machine parameters which change during operation as a function of the operating point (current amplitude and/or rotor temperature). If the parameter values are not chosen correctly or are matched insufficiently to the present operating state, it may frequently arise that it is necessary to take protective measures which go beyond current limiting, such as disabling the converter.

### SUMMARY OF THE INVENTION

It is an object of the present invention to specify an open-loop and/or closed-loop control device for the operation of a three-phase machine which is fed by a three-phase converter, wherein the device limits the stator current effectively and reliably to admissible values, wherein a high level of dynamics for the operation of the machine is made possible and wherein the frequent occurrence of secondary protective measures, such as disconnection of the converter, is avoided. The stator current is understood to mean the current through the stator winding of the machine.

According to one basic concept of the present invention, within a closed-loop control structure with stator flux and slip frequency regulation (or alternatively stator flux and torque regulation), both the flux-forming and torque-forming stator currents are limited by means of respective intervention in the two control loops. Unlike in the case of the aforementioned method from Maischak, there is no prerequisite of quasi-steady-state operation for the magnetization of the machine.

In this case, the torque-forming current is limited by limiting the setpoint value supplied to the slip frequency regulator (or torque regulator) to a maximum value (subsequently: the maximum slip frequency or torque value).

Limiting both the flux-forming and torque-forming stator currents by intervening in the control loops of the stator flux regulator and the slip frequency regulator (or the torque regulator) also automatically, without further measures being required, solves the following problem: since the total current through the stator, i.e. the stator current fundamental-frequency magnitude, is limited to a maximum value, methods which are known from the prior art require stipulation of whether the flux-forming or torque-forming stator current component needs to be maintained as priority, i.e. the other current component needs to be reduced, in order to observe the maximum value for the total stator current fundamental-frequency magnitude. In the case of the solution according to the present invention, the priority for the reduction is obtained automatically without further measures. Exemplary embodiments of various operating situations in which at least one component of the stator current needs to be reduced will be explained in the description of the figures.

In addition, the flux-forming current is limited by limiting the speed at which the setpoint stator flux changes (preferably both to higher and to lower flux values) to a maximum value (subsequently: maximum flux ramp increment). This is achieved preferably by limiting the setpoint value change at the input of the stator flux regulator using a ramp element (i.e. a device which limits the change in accordance with a time ramp) if the setpoint value corresponds to an excessive speed of change. In this case, the speed forms the basis for the rise/fall in the flux between two subsequent operating clock cycles in the open-loop and/or closed-loop control device.

The two maximum values (the maximum slip frequency or torque value and the maximum flux ramp increment) are stipulated continuously or quasi-continuously during the operation of the open-loop and/or closed-loop control device such that no inadmissibly large current amplitudes in the stator current occur. In other words, at least one maximum value for the stator current (particularly a maximum value for the flux-forming component of the stator current fundamental and a maximum value for the total stator current fundamental-frequency magnitude) is used to calculate a maximum value for the speed of rise of the stator flux and a maximum value for the torque or the slip frequency and to take measures to ensure that these two maximum values (the maximum slip frequency or torque value and the maximum flux ramp increment) are not exceeded.

In particular, the following is proposed: an open-loop and/or closed-loop control device for the operation of a three-phase machine which is fed by a 3-phase converter. The device has a structure, namely an open-loop and/or closed-loop control structure. The structure has a stator flux regulator and a slip frequency regulator or the structure has a stator flux regulator and a torque regulator. The structure has a first limiting device which is configured to limit the torque-forming fundamental-frequency current component of the stator current by limiting a setpoint value that is supplied to the slip frequency regulator or to the torque regulator to a maximum slip frequency value or maximum torque value. The structure has a second limiting device which is configured to limit the flux-forming fundamental-frequency current component of the stator current by limiting the speed at which a setpoint value supplied to the stator flux regulator changes to a maximum value. The structure is configured to calculate the maximum slip frequency or torque value on the basis of a prescribed maximum current value for a stator current fundamental-frequency magnitude, i.e. on the basis of a maximum current value for the fundamental-frequency magnitude of the (total) stator current (formed by or splittable into the q and d components), and on the basis of a filtered actual value of a flux-forming component (d component) of the stator current.

In addition, the following is proposed: a method for the operation of a three-phase machine, which is fed by a three-phase converter, using a stator flux regulator and a slip frequency regulator or using a stator flux regulator and a torque regulator. In the method the torque-forming fundamental-frequency current component of the stator current is limited by limiting a setpoint value that is supplied to the slip frequency regulator or to the torque regulator to a maximum slip frequency or torque value. The flux-forming fundamental-frequency current component of the stator current is limited by limiting the speed at which a setpoint value supplied to the stator flux regulator changes to a maximum value. The maximum slip frequency value or maximum torque value is calculated on the basis of a prescribed maximum current value for a stator current fundamental-frequency magnitude and on the basis of a filtered actual value of a flux-forming fundamental-frequency current component (d component) of the stator current.

The open-loop and/or closed-loop control device is used particularly advantageously when the three-phase machine is an asynchronous machine and the structure has the stator flux regulator and the slip frequency regulator.

Suitable appropriate devices in the closed-loop control structure which ensure that the prescribed maximum values for the stator current fundamental and the flux-forming current component are observed are preferably what are known as limiting regulators. These are understood to mean closed-loop controllers which, in normal operation (i.e. when the admissible maximum value of the limiting regulator has not been exceed), do not exert any influence on the setpoint variable which is relevant to the operation of the associated closed-loop controller (in this case the slip frequency regulator or torque regulator or the stator flux regulator). If, by contrast, the setpoint value exceeds the admissible maximum value, the operation of the limiting regulator has a limiting effect on the setpoint value, as a result of which the exceeding is prevented by means of the underlying control loop. In the case of the flux ramp increment, the underlying control loop is the control loop of the flux regulator; in the case of the maximum slip frequency value or maximum torque value, it is the control loop of the slip frequency regulator or torque regulator.

Limiting is understood to mean particularly limiting of the magnitude, i.e. torques generated for braking a rail vehicle can also be limited, for example. The limiting regulator therefore acts on the setpoint variable of the respectively associated closed-loop controller, i.e. it acts on the setpoint value which is applied to the input of the associated closed-loop controller.

The speed of rise for the stator flux is preferably limited by calculating the admissible change in the stator flux, i.e. the increment, for each operating clock cycle of the structure. If the difference between the stator flux setpoint value from the preceding operating clock cycle, on the one hand, and the stator flux setpoint value in the present operating clock cycle, on the other hand, exceeds the increment then the stator flux setpoint value from the present operating clock cycle is limited such that the maximum admissible increment is not exceeded.

Advantageously, the speed of flux change is limited (i.e. the maximum flux ramp is observed) by using a limiting regulator structure which is supplied with the filtered magnitude of the actual value and with a maximum value of the flux-forming component (d component in the coordinate system d-q, which is fixed to the rotor) of the stator current. As otherwise too, this is the fundamental-frequency-oriented component, that is to say without harmonic components. Preferably, this limiting regulator has a P controller, i.e. a closed-loop controller whose manipulated variable is proportional to the setpoint/actual-value error (in this case the difference between the setpoint value and the maximum value of the flux-forming component of the stator current) at the input of the closed-loop controller.

It is likewise preferred for the structure to be designed to supply the difference between a prefiltered actual value of the torque-forming component (q component, fundamental-frequency-oriented) of the stator current and a maximum value of the torque-forming component (fundamental-frequency-oriented) of the stator current to a proportional integral controller (PI controller), the output of which is connected to an input of the first limiting device.

The stator current limiting according to the invention can be applied particularly in the case of operating states of the machine with a high level of dynamics (e.g. in the case of the aforementioned change from rolling to dynamic braking of a vehicle). High torques and large changes in the stator flux can be permitted simultaneously.

According to a further concept of the invention, when calculating the maximum slip frequency value or the maximum torque value it is not (as in the case of Maischak, see above) assumed that the flux change in the magnetic flux is approximately equal to zero, since the associated negligence has been identified as one of the causes of the frequent overcurrent disconnections. On the contrary, the admissible maximum value of the torque-forming stator current (q component in the d-q coordinate system) is calculated using a filtered actual value (in contrast to the steady-state magnetization current used by Maischak) of the flux-forming fundamental-frequency current (d component in the coordinate system d-q which is fixed to the rotor) and using the known value for the maximum value of the total stator current fundamental-frequency value. This is in turn used to calculate the admissible maximum value of the slip frequency or torque.

Using the filtered fundamental-frequency actual value instead of the steady-state magnetization current for the flux-forming component of the stator current overcomes the difficulty that maximum values need to be calculated or estimated both for the d component and for the q component of the stator current, but sufficient information is not normally available for this. If fixed maximum values which are constant over time were used both for the d component and for the q component, on the other hand, the maximum possible total current magnitude of the stator current would not be used, which is important particularly for the operation of rail vehicles.

Other features which are considered as characteristic for the invention are set forth in the appended claims.

Although the invention is illustrated and described herein as embodied in an overcurrent limiting for the closed-loop control of converter-fed three-phase machines, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram of an arrangement of a three-phase machine which is fed by a three-phase converter, wherein an operation of the converter and hence the three-phase machine is regulated by a closed-loop control structure;

FIG. 2 is a block diagram of a substructure of the closed-loop control structure shown in FIG. 1, but with a slip frequency regulator instead of a torque regulator;

FIG. 3 is a block diagram of a preferred embodiment of the limiting device shown in FIG. 2 for limiting the flux-forming stator current component;

FIG. 4 is a block diagram of a preferred embodiment of the device shown in FIG. 2 for calculating the maximum value of the setpoint value of the torque-forming stator current component;

FIG. 5 is a block diagram of a preferred embodiment of the limiting device shown in FIG. 2 for limiting the torque-forming stator current component; and

FIG. 6 is a graph illustrating different operating situations in which an excessive stator current is demanded, the illustration showing a quadrant in the coordinate system d-q, which is fixed to the rotor flux.

### DETAILED DESCRIPTION OF THE INVENTION

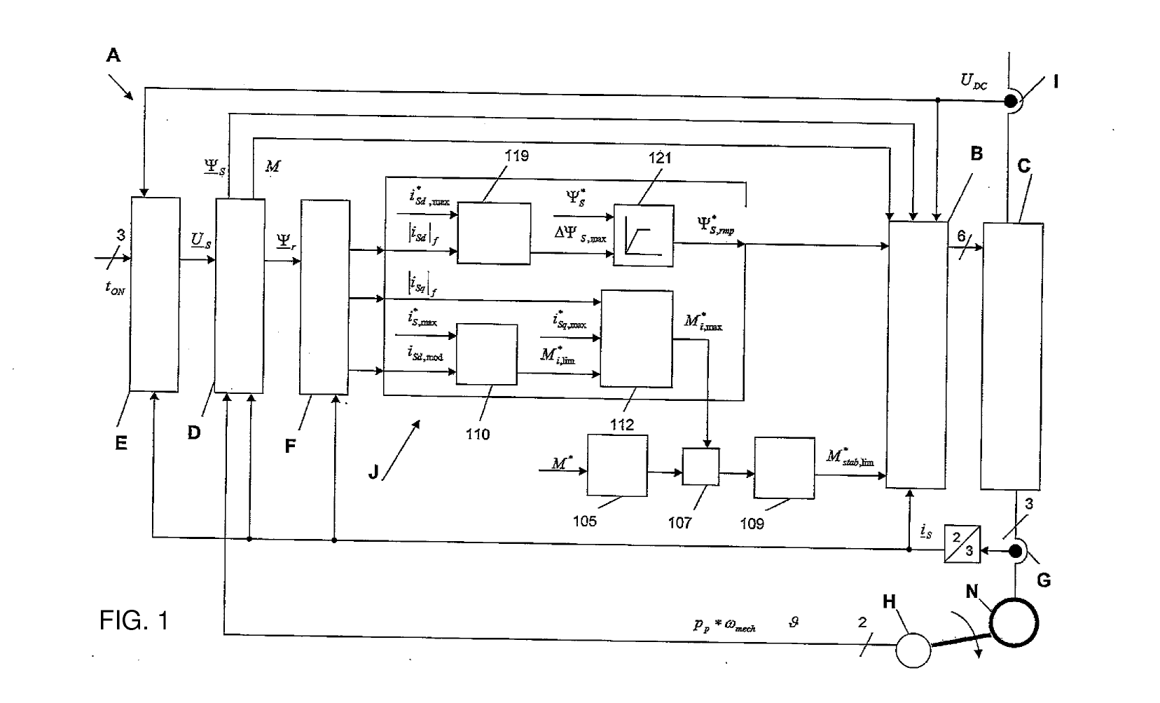

Referring now to the figures of the drawing in detail and first, particularly, to FIG. 1 thereof, there is shown a structure A for the overall drive control of a three-phase machine N which can be operated either with or without a speed sensor or rotary encoder. The three-phase machine N may be an asynchronous machine or a synchronous machine, preferably with permanent-magnet excitation. Specifically, the following are shown and provided with the subsequent reference symbols: a unit B which contains a pulse pattern generator, a torque regulator and a flux regulator, a converter C (i.e. a 3-phase inverter), which receives the actuation pulses from the unit B and accordingly supplies the machine N with current via three phases, a device D for reproducing the flux concatenations (stator and rotor flux) and a torque (flux monitor), a device E for calculating the output voltage of the converter C, and a unit F which has transformation of measured current values from at least two of the three phases into the coordinate system d-q which is fixed to the rotor flux and filters for smoothing the current values. An appropriate measuring device for measuring the phase current values is denoted by G. The measured current values are supplied via an appropriate line connection both to the device D, the unit F, the unit E and to the unit B.

Optionally, a measuring device H is provided for measuring the speed or the angle of rotation of the machine N. The result of the speed measurement or estimation or angle-of-rotation measurement or estimation is supplied to the device D.

In addition, a measuring device I measures the DC voltage on the DC voltage side of the converter C and supplies it to the unit B and to the device E.

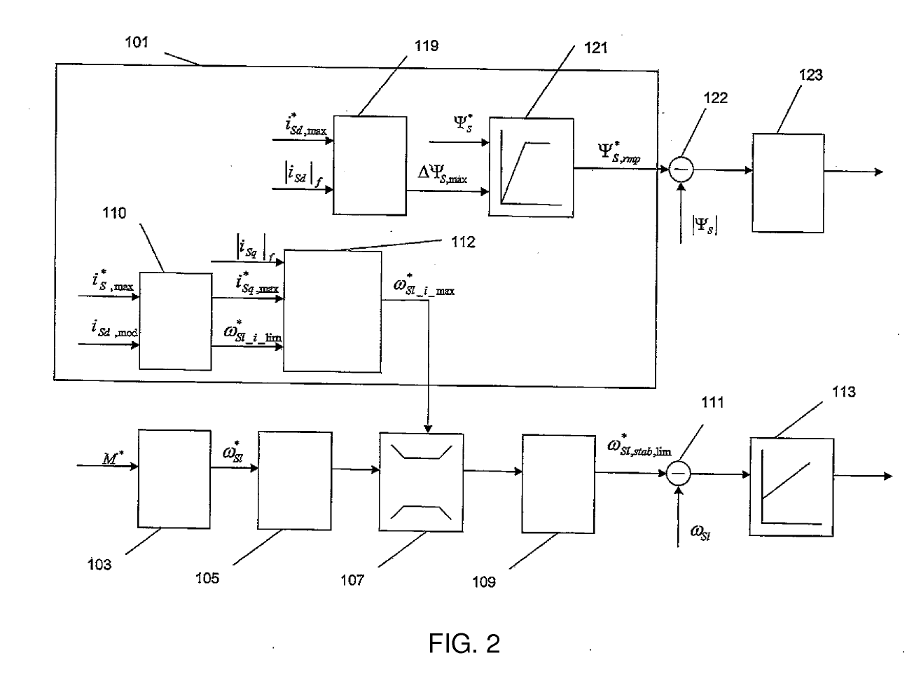

One preferred embodiment of the present invention is provided by the substructure J, which is shown in the center of FIG. 1 and which is described in more detail in a slightly modified variant also with reference to FIG. 2. Only the interfaces to the other portions of the structure A are described with reference to FIG. 1.

The unit F supplies the structure with the filtered absolute values of the current fundamental-frequency components in the coordinate system d-q which is fixed to the rotor flux, i.e. the magnitude |i_{Sd}|_{f} of the flux-forming current fundamental-frequency component i_{Sd} and the magnitude |i_{Sq}|_{f} of the torque-forming current fundamental-frequency component i_{Sq}. In this case, smoothed, i.e. filtered, magnitudes, which correspond to the fundamental-frequency values, are produced and output by the unit F. In addition, the unit F also outputs the arithmetically signed filtered actual value of the flux-forming current fundamental-frequency component i_{Sd,mod} to the substructure J.

Output variables from the substructure J are the setpoint values for the two closed-loop controllers in the unit B, the stator flux regulator and the torque regulator. In the case of the variant of the substructure shown in FIG. 2, a slip frequency regulator is provided instead of the torque regulator. The substructure shown in FIG. 2 therefore outputs a slip frequency setpoint value ω* instead of the torque setpoint value M*. The setpoint value for the stator flux regulator is in both cases a rise-limited setpoint value ψ*_{S,rmp}, with rise also being understood to mean a fall. In other words, the speed at which the setpoint value of the stator flux can rise or fall is limited by the substructure J.

The pulse pattern generator in the unit B may be provided within signal-controlled or microprocessor-controlled signal electronics, for example. As described in more detail in international patent disclosure WO 2008/052714 A1, it may have particularly a closed-loop control method implemented in it with mean-value-based pulse pattern generation and a dead-beat response from the stator flux regulation. Furthermore, it may contain an implementation of a stator-flux-led, instantaneous-value-based pulse pattern generator. Reference is made to WO 2008/052714 A1 for other possible refinements of the structure A too.

FIG. 2 shows the aforementioned variant of the substructure J using the example of the advantageous embodiment with underlying stator flux regulation and slip frequency regulation as shown in FIG. 1. Apart from the filtered magnitudes of the flux-forming and torque-forming fundamental-frequency current and of the filtered actual value of the flux-forming fundamental-frequency current which have already been mentioned with reference to FIG. 1, input variables for the substructure are a maximum setpoint value of the flux-forming fundamental-frequency current i*_{Sd,max} and a setpoint value M* of the torque of the machine N and also the maximum value of the total stator current fundamental-frequency magnitude i_{S,max}.

A region of the substructure which is shown at the top left in FIG. 2 has a rectangular frame 101 drawn around it. This region contains embodiments of essential elements of the present invention. These include particularly the limiting devices for limiting both the flux-forming (d component) and the torque-forming (q component) stator fundamental-frequency current. The limiting device for the d component is denoted by the reference symbol 119, and the limiting device for the q component is denoted by the reference symbol 112.

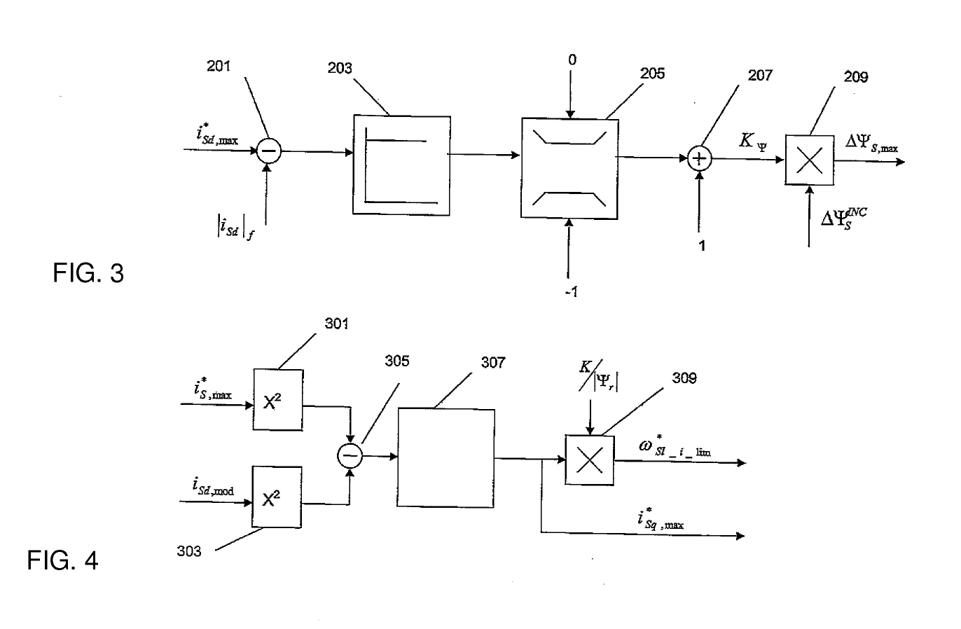

The limiting device 119 is supplied with the filtered magnitude |i_{Sd}|_{f} of the actual value of the flux-forming current fundamental-frequency component i_{Sd} and with the maximum setpoint value i*_{Sd,max} of the flux-forming current fundamental-frequency component i_{Sd}. As described in even more detail with reference to an exemplary embodiment as shown in FIG. 3, the limiting device 119 uses these to calculate the maximum increment Δψ_{S,max} for the stator flux magnitude |ψ_{S}|. This output variable is supplied to a unit 121 as an input variable. A further input variable for this unit is the setpoint value ψ*_{S} of the stator flux magnitude. From this, the unit 121 calculates—as an output variable—a rise-limited setpoint value ψ*_{S,rmp} which is limited in respect of the speed of rise in accordance with the output value for the unit 119. As a result, the limiting device 119 has merely a limiting effect on the setpoint value ψ*_{S} of the stator flux magnitude should the latter exceed the maximum permitted speed of rise in the present operating clock cycle.

A differential element 122 forms the difference between the limited setpoint value of the stator flux magnitude ψ*_{S,rmp} and the magnitude of the actual value of the stator flux |ψ_{S}|. This difference is supplied to the flux regulator 123 as a control error. In the illustration shown in FIG. 1, the differential element 122 and the stator flux regulator 123 would be inside the unit B, but are not shown therein. The magnitude of the actual value of the stator flux is supplied to the unit B by the device D.

The lower portion of the region 101 inside the substructure which is shown in FIG. 2 shows a calculation device 110 which is supplied with the maximum value i*_{S,max} of the stator current fundamental-frequency magnitude i_{S} and with the filtered actual value i_{Sd,mod} of the flux-forming stator current fundamental-frequency component as input values. The filtered actual value i_{Sd,mod} can be filtered, in particular, in a different way than the values of the flux-forming and torque-forming current fundamental-frequency components. The calculation inside the device 110 is performed on the basis of the following equations:

|i_{S,max}|²=(i_{Sd,mod})²+(i*_{Sq,max})² (equation 1)

i*_{Sq,max}=\sqrt{(i_{S,max})²−i_{Sd,mod}²} (equation 2)

Equation 1 shows the relationship between the square of the stator current fundamental-frequency magnitude i_{S}, i.e. the square of the stator current phasor in the d-q coordinate system fixed to the rotor flux, on the one hand, and the sum of the squares of the stator-flux-forming i_{Sd} and torque-forming i_{Sq} current components in the d-q coordinate system. All variables in equation 1 relate to the fundamental, i.e. without harmonics, of the stator current. In this context, equation 1 uses the variables which are the input variables and output variables of the calculation device 110. When resolved on the basis of the output variable, the maximum setpoint value i*_{Sd,max} of the torque-forming stator current fundamental-frequency component (q component), equation 2 is obtained.

Furthermore, the calculation device 110 outputs a value for the slip frequency ω*_{Sl}_{_{—}}ᵢ_{_{—}}ₗᵢₘ, which is obtained by multiplying the other output value by a factor K divided by the magnitude of the rotor flux ψᵣ. These two output values from the calculation device 110 are supplied as input values to the limiting device 112 for the purpose of limiting the torque-forming current fundamental-frequency component of the stator current. In addition, the limiting device 112 receives the magnitude of the filtered fundamental-frequency actual value of the torque-forming current component |i_{Sq}|_{f} as an input variable.

As an output variable, in the case of the embodiment shown in FIG. 2, the limiting device 112 produces the maximum value of the setpoint value of the slip frequency ω*_{Sl}_{_{—}}ᵢ_{_{—}}ₘₐₓ which is admissible as a maximum in the present operating clock cycle. This maximum value is supplied to a limiter 107, which activates limiting of the slip frequency. This is understood to mean that the setpoint value of the slip frequency ω*_{Sl} is limited to said maximum value. If the setpoint value of the slip frequency in the present operating clock cycle is not greater than the maximum value or is not less than the negative value of the maximum value, the limiter 107 does not alter the setpoint value. Otherwise, the setpoint value is reduced or increased (in consideration of the correct arithmetic sign) to the maximum value or the negative of the maximum value.

In the case of the substructure J shown in FIG. 1, the limiting device 112 would produce a maximum value for the torque of the machine and would output it to the limiter 107.

As illustrated in more detail at the bottom in FIG. 2, it is optionally possible for further limiting operations to take place on the torque setpoint value and/or the slip frequency setpoint value.

In particular, the torque setpoint value M* can be converted into the slip frequency setpoint value ω*_{Sl} in the device 103 shown, and this converted value can be limited in advance in unit 105 before it is supplied to the limiter 107, that is to say as an unlimited setpoint value within the context of limiting by the limiter 107, in order to provide tilt protection for the machine, power limiting for the machine, current limiting for the converter input direct current and/or wheel slip control for the slippage which is possible on the wheels of a rail vehicle. In principle, such closed-loop control operations and limiting operations can alternatively be performed on the output value from the limiter 107, but the order shown in the exemplary embodiment in FIG. 2 is particularly advantageous.

In the exemplary embodiment shown in FIG. 2, what is known as U_{d} disconnection is also provided for the purpose of damping oscillations in the DC voltage circuit on the DC voltage side of the converter C shown in FIG. 1 in unit 109. A more precise description of the U_{d} disconnection can be found in German patent DE 4110225, for example. The output value from the unit 109 (if present) or the output value from the limiter 107 is supplied to a differential element 111 which forms the difference with respect to the actual value of the slip frequency ω_{Sl} and supplies the difference as a control error to the slip frequency regulator 113. In the case of the variation with a slip frequency regulator, the differential element 111 and the slip frequency regulator 113 would be situated in block B in FIG. 1. In the case of the torque regulator, the limiter 107 accordingly outputs a limited setpoint value for the torque and the differential element 111 forms the difference with respect to the actual value of the torque and supplies the difference as an input control error to the torque regulator.

FIG. 3 shows a preferred embodiment of the limiting device 119 shown in FIG. 1 for limiting the flux-forming stator current fundamental-frequency component i_{Sd}. The limiting device prompts the limiting by limiting the spesed of rise of the magnetic flux. The input variables supplied to the structure are the absolute values |i_{Sd}|_{f} of the filtered actual value of the flux-forming current (d component of the stator current fundamental) and the maximum value i*_{Sd,max} of the flux-forming fundamental-frequency current. The superscript asterisk in the symbol means (as also elsewhere in this description) that the value is a setpoint value. These two input variables are deducted from one another in the differential element 201 and the difference is supplied to the proportional controller 203 as an input signal. In the exemplary embodiment, the proportionality factor which is multiplied by the input difference prompts normalization of the variable. The output value from the closed-loop controller is supplied to a limiting element 205 which limits this input value to the value 0 at the top and the value −1 at the bottom. According to the optional embodiment shown, the limited value available at the output of the limiting element 205 is supplied to the unit 207, which increases the normalized value, situated in the range from −1 to 0, by 1, so that it is situated in the range from 0 to 1. The value obtained in this manner is denoted by the symbol K_{ψ} in FIG. 3. It is supplied to a multiplier 209 as a first input signal. A further, second input signal for the multiplier 209 is the maximum increment in the stator flux magnitude Δψ_{S}^{INC}, a prescribed parameter. As a result, the output signal obtained from the limiting device 119 in the embodiment shown in FIG. 2 is the maximum value Δψ_{S,max} of the increment in the stator flux magnitude for the present operating clock cycle. The effect of this maximum value Δψ_{S,max} has been described with reference to FIG. 1.

FIG. 4 shows an embodiment of the calculation device 110 shown in FIG. 2. The two input values are each supplied to a squaring element 301 or 303 which squares the input values according to equation 1 or equation 2. The squared values are supplied to a differential element 305, which takes equation 2 as a basis for calculating the argument of the square root on the right-hand side of the equation. This argument is supplied to a device for calculating the square root 307, which calculates the result on the right-hand side of equation 2. The output of the calculation device 307 therefore provides the first output value from the calculation device 110, namely the maximum setpoint value of the torque-forming current fundamental-frequency component i*_{Sq,max}. As already described, this first output value is converted into the relevant value of the slip frequency by multiplying it by the factor K divided by the magnitude of the rotor flux |ψᵣ|. The relevant multiplier device is denoted by the reference symbol 309. The factor K is a combination of variables. Equation 3 below shows the relationship between the two output variables from the calculation device 110 and hence also the variables which form the factor K:

$${ω}_{S 1 \_ i \_ lim}^{*} = {R}_{r}^{′} \cdot \frac{{L}_{s}}{{L}_{s} + {L}_{σ}^{′}} \cdot \frac{1}{\vert {\underline{Ψ}}_{r} \vert} \cdot {i}_{Sq , max}^{*} \qquad ( Equation 3 )$$

In this context: R′ᵣ denotes the rotor resistor transformed into the gamma equivalent circuit diagram, L_{S} denotes the inductance of the stator winding, L′_{σ} denotes the stray inductance of the gamma equivalent circuit diagram of the asynchronous machine.

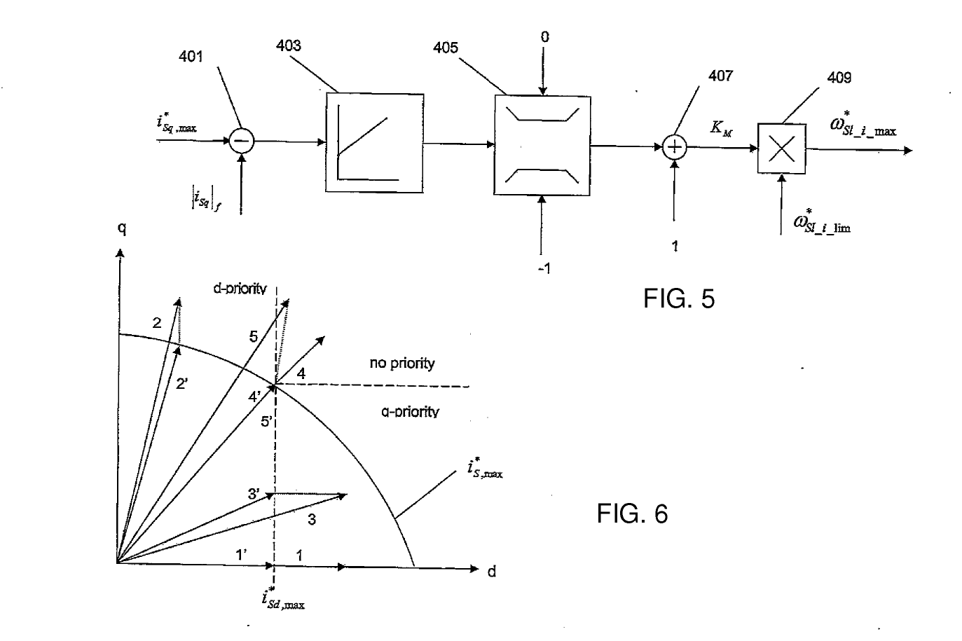

FIG. 5 shows an embodiment of the limiting device 112 shown in FIG. 2. As already mentioned, the input variables supplied to the limiting device 112 are the maximum setpoint value i*_{Sq,max} of the torque-forming component (q component) of the stator fundamental-frequency current and the filtered magnitude of the fundamental-frequency actual value |i_{Sq}|_{f} of this component. A differential element 401 forms the difference between the input variables and supplies the difference as a control error to a closed-loop controller 403, which is a PI controller in the exemplary embodiment. In contrast to the use of a P-controller for limiting the flux-forming current component (see FIG. 3), a PI controller with an additional integral component is preferred for limiting the torque-forming current component.

The output value from the closed-loop controller 403 is supplied to a limiter 405, which limits the output value from the closed-loop controller, which output value is normalized on account of the appropriately chosen proportionality factor of the closed-loop controller 403, in the range from −1 to 0. The thus limited output value from the limiter 405 is applied to a summator 407, which adds the value 1, so that the output value from the summator 401, which is denoted by K_{M}, is limited to the value range from 0 to 1. A multiplier 409 multiplies this value K_{M} by the second output value from the calculation device 110, the maximum setpoint value ω*_{Sl}_{_{—}}ᵢ_{_{—}}ₗᵢₘ of the slip frequency, by virtue of the downstream multiplier 409, so that an appropriate limited maximum setpoint value ω*_{Sl}_{_{—}}ᵢ_{_{—}}ₘₐₓ of the slip frequency is obtained as output value. As has been described with reference to FIG. 2, this output value is supplied to the limiter 107.

FIG. 6 shows the first quadrant of the coordinate system d-q which is fixed to the rotor. Along the horizontal axis, the d axis, the flux-forming or magnetizing current component of the stator current i_{Sd} therefore increases. Along the q axis, the vertical axis, the component of the torque-forming stator current i_{Sq} increases.

The quadrant arc in the quadrant, the center of which is at the origin of the coordinate system d-q, corresponds to the admissible maximum value of the total stator current fundamental-frequency value i*_{S,max}. None of the current space vectors (also called current vectors) extending through the quadrant from the origin and each corresponding to a demand for a current is therefore able to extend beyond the quadrant arc. This is the case for the current phasors denoted by the numerals 2, 4 and 5. Therefore, the limiting regulation according to the invention intervenes and reduces these current space vectors, as described in more detail below. In this case, it is possible to alter not only the magnitude of the respective current space vector but also the direction thereof, depending on the operating situation.

Furthermore, a maximum value exists for the flux-forming current fundamental-frequency component of the stator current, which is shown in the figure by a vertical, dashed line. The maximum value is denoted by the symbol i*_{Sd,max}. Although two of the current phasors, denoted by the numerals 1 and 3, end within the quadrant arc of the maximum admissible total current fundamental-frequency magnitude i_{S,max}, they project over the vertical dashed line at the location i*_{Sd,max}, i.e. they exceed the limit value for the maximum admissible flux-forming fundamental-frequency current. As explained in more detail below, these current space vectors are limited solely by reducing the flux-forming current component i_{Sd} to an admissible current space vector.

Apart from the maximum value for the total stator current fundamental-frequency magnitude, there is also a maximum value for the flux-forming current component i_{Sd}, as shown in FIG. 6. In accordance with the preferred refinement of the invention, the observation of the limit value during flux changes is ensured by a separate limiting regulator (see FIGS. 2 and 3). As a result of the effect of this limiting regulator (in the exemplary embodiment in FIG. 3, with a P controller), the limit value can be intermittently at least slightly exceeded, however.

The various situations shown in FIG. 6 which are caused by excess current demand will now be discussed below. In the case of the current space vector 1, a current is demanded which contains exclusively a flux-forming current component. Although the peak of the demanded current space vector is situated inside the quadrant arc, i.e. the total maximum stator current fundamental-frequency value is not exceeded, the limit value for the flux-forming fundamental-frequency component of the current i*_{Sd,max} is exceeded. Therefore, the effect of the separate closed-loop controller accordingly reduces the current to the current vector denoted by 1′.

A similar case is shown by the current space vectors which are denoted by the symbols 3 and 3′. This case differs from case 1 only in that both current space vectors, the excessive demanded current space vector and the reduced current space vector, also have a torque-forming current component. This torque-forming current component remains the same, i.e. is not affected by the alteration of the current phasor. Only limiting the flux-forming component prompts the flux-forming component of the reduced current vector no longer to exceed the limit value i_{sd,max}. Cases 1 and 3 have a demanded current vector, the peak of which is situated in a region of the first quadrant of the d-q coordinate system which is denoted by “q-priority”. As has just been described, the q component, i.e. the torque-forming current component i_{Sq}, is not affected when the demanded current vector is reduced to an admissible current vector. It therefore has priority over the flux-forming current component i_{Sd}. This region with q-priority ends on the left at the maximum value for the flux-forming current component i*_{Sd,max}. At the top, this region with q-priority ends at the horizontal line which runs through the point of intersection between the maximum value line of i*_{Sd,max} and the quadrant arc. Directly above the region with q-priority, likewise to the right of the vertical, dashed line for i_{Sd,max}, there is a region without priority. If the peak of a requested current space vector is situated in this region, the current space vector is reduced to alter both the d component and the q component of the stator current. This type of limiting of space vectors is also called limiting for the correct angle. In the illustration in FIG. 6, this has two corresponding exemplary cases. In the case of the demanded current space vector 4, this current space vector crosses the quadrant arc for the maximum value i*_{S,max} of the total stator current precisely at the boundary line between the region with q-priority and the region with no priority. Since the limiting to the maximum value of the flux-forming current and limiting to the maximum value of the total stator current achieve a current space vector which ends precisely at this point of intersection between the current space vector 4 and the quadrant arc, no change of direction is performed on the current phasor in case 4, that is to say limiting for the correct angle as mentioned above.

By contrast, in the case of the current space vector 5, such a change of direction again takes place. The current space vector 5 is likewise reduced to the admissible current space vector, which ends at the point of intersection between the boundary line between the two cited priority regions or the region with no priority and the quadrant arc. This arrow which ends at that point is therefore denoted by the reference symbols 4′ and 5′.

Above the quadrant arc and to the left of the maximum value for the flux-forming current component i*_{Sd,max}, there is the region with “d-priority” (denoted by “d-priority” in the illustration). At that point, the demanded current vector 2 ends in the exemplary embodiment. It is thus automatically reduced, using the limiting regulation according to the invention, to an admissible current vector 2′ which has the same flux-forming current component i_{Sd}, but which has a torque-forming current component which is reduced in accordance with the admissible total maximum stator current fundamental-frequency value. Since no reduction of the flux-forming current component thus takes place, this region is correctly denoted as a region with d-priority.

1. An open-loop and/or closed-loop control device for operating a three-phase machine fed by a 3-phase converter, the control device comprising:
an open-loop and/or closed-loop control structure containing:
a stator flux regulator;
a further regulator selected from the group consisting of a slip frequency regulator and a torque regulator;
a first limiting device for limiting a torque-forming fundamental-frequency current component of a stator current being the current through a stator of the three-phase machine, by limiting a setpoint value that is supplied to said further regulator to a maximum slip frequency value or a maximum torque value;
a second limiting device for limiting a flux-forming fundamental-frequency current component of the stator current by limiting a speed at which a setpoint value supplied to said stator flux regulator changes to a maximum value; and
said control structure calculating the maximum slip frequency value or the maximum torque value on a basis of a prescribed maximum current value for a stator current fundamental-frequency magnitude of the stator current, and on a basis of an actual value formed by a filtering of measured current values of the stator current corresponding to the flux-forming fundamental-frequency current component of the stator current.

2. The open-loop and/or closed-loop control device according to claim 1, wherein:
said open-loop and/or closed-loop control structure further has a closed-loop control device with a proportional integral controller, said closed-loop control device having an output connected to an input of said first limiting device; and
said open-loop and/or closed-loop control structure supplies a difference of the actual value formed by the filtering of the measured current values of the stator current corresponding to the torque-forming fundamental-frequency current component of the stator current and a maximum value of the torque-forming fundamental-frequency current component of the stator current to said closed-loop control device.

3. The open-loop and/or closed-loop control device according to claim 1, wherein:
said open-loop and/or closed-loop control structure further has a closed-loop control device having a proportional controller, said closed-loop control device having an output connected to an input of said second limiting device; and
said open-loop and/or closed-loop control structure supplies a difference between a filtered actual value of the flux-forming fundamental-frequency current component of the stator current and a maximum value of the flux-forming fundamental-frequency current component of the stator current to said closed-loop control device.

4. The open-loop and/or closed-loop control device according to claim 1, wherein the three-phase machine is an asynchronous machine and said open-loop and/or closed-loop control structure has said stator flux regulator and said slip frequency regulator.

5. A method for operating a three-phase machine fed by a three-phase converter, using a stator flux regulator and a further regulator selected from the group consisting of a slip frequency regulator and a torque regulator, which comprises the steps of:
limiting a torque-forming fundamental-frequency current component of a stator current, being a current through a stator of the three-phase machine, by limiting a setpoint value that is supplied to the further regulator to a maximum slip frequency value or a maximum torque value;
limiting a flux-forming fundamental-frequency current component of the stator current by limiting a speed at which a setpoint value supplied to the stator flux regulator changes to a maximum value; and
calculating a maximum slip frequency value or a maximum torque value on a basis of a prescribed maximum current value for a stator current fundamental-frequency magnitude of the stator current and on a basis of an actual value formed by filtering of measured current values of the stator current corresponding to the flux-forming fundamental-frequency current component of the stator current.

6. The method according to claim 5, which further comprises supplying a difference between the actual value formed by the filtering of the measured current values of the stator current corresponding to the torque-forming fundamental-frequency current component of the stator current and a maximum value of the torque-forming fundamental-frequency current component to a closed-loop control device having a proportional integral controller and wherein an output value from the closed-loop control device is supplied to an input of a first limiting device for limiting the torque-forming fundamental-frequency current component of the stator current.

7. The method according to claim 5, which further comprises:
supplying a difference between a filtered actual value of the flux-forming fundamental-frequency current component of the stator current and a maximum value of the flux-forming fundamental-frequency current component of the stator current to a closed-loop control device having a proportional controller; and
supplying an output value from the closed-loop control device to an input of a second limiting device for limiting the flux-forming fundamental-frequency current component of the stator current.

8. The method according to claim 5, wherein the three-phase machine is an asynchronous machine and the machine is subjected to closed-loop and/or open-loop control using the stator flux regulator and the slip frequency regulator.
